(19) United States
(12) Patent Application Publication
(10) Pub. No.: US 2026/0171101 A1
(43) Pub. Date: Jun. 18, 2026

(54) AUDIO PROCESSING METHOD AND DEVICE

(71) Applicant: Beijing Zitiao Network Technology Co., Ltd., Beijing (CN)

(72) Inventors: Zhuangqi CHEN, Beijing (CN); Xianjun XIA, Beijing (CN); Chuanzeng HUANG, Beijing (CN)

(21) Appl. No.: 19/412,472

(22) Filed: Dec. 8, 2025

(30) Foreign Application Priority Data
Dec. 12, 2024 (CN) 202411834289.7

(51) Int. Cl. G10L 19/02; G10L 25/18; G10L 25/30

(52) U.S. Cl. CPC G10L 19/0204; G10L 25/18; G10L 25/30

(57) ABSTRACT

Embodiments of the present disclosure provide an audio processing method and device, the method including: acquiring audio data of a video file, converting each frame data in the audio data into frequency-domain data through a clipping detection model, and detecting whether clipping data exists in each frame data based on the frequency-domain data; performing, if it is detected that clipping data exists in the frame data, clipping restoration processing on the frame data through a clipping restoration model to obtain restored frame data, the clipping restoration model being configured to filter out clipping data and spectral mirroring from the frame data; and performing normalization processing on audio loudness of the restored frame data based on a maximum amplitude of the restored frame data in a time domain, to obtain restored audio data of the video file.

### CROSS REFERENCE TO RELATED APPLICATIONS

This present application claims the benefit of priority to Chinese Application No. 202411834289.7, filed on Dec. 12, 2024, the entire contents of which are incorporated herein by reference.

### TECHNICAL FIELD

Embodiments of the present disclosure relate to the field of Internet technology, and in particular to an audio processing method and device.

### BACKGROUND

Audio clipping is a common type of sound quality defect. In practical audio recording systems, due to a certain upper limit for recordable audio loudness, when the loudness of the sound to be recorded is too high, clipping occurs. In terms of auditory perception, clipping presents as noise similar to crackling or rumbling sounds, and its presence degrades the user's listening experience.

### SUMMARY

The embodiments of the present disclosure provide an audio processing method and device.

In a first aspect, an embodiment of the present disclosure provides an audio processing method, including:
acquiring audio data of a video file, converting each frame data in the audio data into frequency-domain data through a clipping detection model, and detecting whether clipping data exists in each frame data based on the frequency-domain data;
performing, if it is detected that clipping data exists in the frame data, clipping restoration processing on the frame data through a clipping restoration model to obtain restored frame data, the clipping restoration model being configured to filter out clipping data and spectral mirroring from the frame data; and
performing normalization processing on audio loudness of the restored frame data based on a maximum amplitude of the restored frame data in a time domain, to obtain restored audio data of the video file.

In a second aspect, an embodiment of the present disclosure provides an audio processing device, including:
an acquisition unit, configured to acquire audio data of a video file, convert each frame data in the audio data into frequency-domain data through a clipping detection model, and detect whether clipping data exists in each frame data based on the frequency-domain data;
an audio processing unit, configured to perform, if it is detected that clipping data exists in the frame data, clipping restoration processing on the frame data through a clipping restoration model to obtain restored frame data, the clipping restoration model being configured to filter out clipping data and spectral mirroring from the frame data; and
a limiting unit, configured to perform normalization processing on audio loudness of the restored frame data based on a maximum amplitude of the restored frame data in a time domain, to obtain restored audio data of the video file.

In a third aspect, an embodiment of the present disclosure provides an electronic device, including: a processor and a memory;
where the memory stores computer-executable instructions; and
where the processor executes the computer-executable instructions stored in the memory, causing the at least one processor to perform the audio processing method according to the first aspect and various possible designs of the first aspect as described above.

In a fourth aspect, an embodiment of the present disclosure provides a computer-readable storage medium having computer-executable instructions stored thereon, where the computer-executable instructions, when executed by a processor, implement the audio processing method according to the first aspect and various possible designs of the first aspect as described above.

In a fifth aspect, an embodiment of the present disclosure provides a computer program product including a computer program which, when executed by a processor, implements the audio processing method according to the first aspect and various possible designs of the first aspect as described above.

The embodiments provide an audio processing method and device, the method including: acquiring audio data of a video file, converting each frame data in the audio data into frequency-domain data through a clipping detection model, and detecting whether clipping data exists in each frame data based on the frequency-domain data; performing, if it is detected that clipping data exists in the frame data, clipping restoration processing on the frame data through a clipping restoration model to obtain restored frame data, the clipping restoration model being configured to filter out clipping data and spectral mirroring from the frame data; and performing normalization processing on audio loudness of the restored frame data based on a maximum amplitude of the restored frame data in a time domain, to obtain restored audio data of the video file.

### BRIEF DESCRIPTION OF THE DRAWINGS

In order to more clearly illustrate the embodiments of the present disclosure or the technical solutions in the related art, the drawings used in the embodiments or the description of the related art will be briefly described below, and it is obvious that the drawings in the following description are some embodiments of the present disclosure, and those skilled in the art can obtain other drawings without inventive labor.

FIG. 1 is a schematic view of an application scenario of an audio processing method provided in an embodiment of the present disclosure;

FIG. 2 is a first flowchart of an audio processing method provided in an embodiment of the present disclosure;

FIG. 3 is a first schematic diagram of an audio processing method provided in an embodiment of the present disclosure;

FIG. 4 is a second schematic diagram of an audio processing method provided in an embodiment of the present disclosure;

FIG. 5 is a schematic structural diagram of an audio processing device provided in an embodiment of the present disclosure;

FIG. 6 is a schematic structural diagram of an electronic device provided in an embodiment of the present disclosure.

### DETAILED DESCRIPTION

To make the objects, technical solutions and advantages of the embodiments of the present disclosure more apparent, the technical solutions in the embodiments of the present disclosure will be described clearly and completely with reference to the drawings herein, and it is obvious that the described embodiments are some, but not all embodiments of the present disclosure. All other embodiments obtained by those skilled in the art based on the embodiments disclosed herein without inventive labor, are intended to fall within the scope of the present disclosure.

Audio clipping is a common type of sound quality defect. In practical audio recording systems, due to a certain upper limit for recordable audio loudness, when the loudness of the sound to be recorded is too high, clipping occurs. In terms of auditory perception, clipping presents as noise similar to crackling or rumbling sounds, and its presence degrades the user's listening experience.

Furthermore, during audio processing, the presence of clipping can also limit the effectiveness of processing algorithms and may even produce unreasonable results. For instance, in echo cancellation algorithms, if clipping occurs in a captured signal, the correlation calculation between a reference signal and the captured signal will become inaccurate, potentially causing echo leakage. Therefore, it is necessary to process clipping in audio data to improve user experience.

In the existing mainstream clipping restoration methods, clipping restoration is considered to be an inverse problem, where the true data of the clipping segments is inferred based on the observed non-clipping data, and a solution is derived by combining theories related to constrained optimization methods. Among these, sparsity-based clipping restoration is the most common method. However, such methods make a sparsity assumption for audio signals, causing their limitations in many practical application scenarios, particularly in some complex video content scenarios where the audio is often a mixture of various sound sources, making it difficult to satisfy the sparsity assumption. In addition, such methods further depend on sample point level clipping detection. When dealing with soft clipping, codec distortion, or post-production editing by video creators (variable sampling, overlapping with other components, or the like), the detection accuracy for clipping segments drops significantly, resulting in the limited or even failed final restoration effect. Consequently, the clipping restoration methods described above have a low accuracy.

It is thus evident that there is an urgent need for an effective technical solution to improve the accuracy of clipping restoration methods.

In video production scenarios, editing audio content to increase loudness readily induces the audio clipping phenomenon. Some audio editing software will use a limiter to limit the audio that exceeds a threshold, resulting in soft clipping. Unlike hard clipping, this type of clipping cannot be detected directly based on amplitude values in the time-domain waveform, making the clipping restoration task more challenging. The present disclosure mainly focuses on the issue of audio clipping in video production scenarios, and aim to design a universal clipping restoration method, which can restore any audio content and any sampling rate, and is applicable to audio clipping in the scenarios such as variable sampling, and codec distortions, etc.

In view of the technical problem in the related art, the inventor's technical concept is as follows: since distinct characteristics of clipping can be observed in the frequency domain, such as local spectral energy leakage, the present disclosure considers performing clipping detection in the frequency domain. During clipping restoration, it is necessary to compensate for some positions (positions at which spectral energy leaks) and suppress other positions (positions to which spectral energy at other positions leaks). At this time, a model needs to perform both addition and subtraction, resulting in a heavy learning burden and limited effectiveness. In contrast, in the time domain, it is only necessary to compensate for the clipped components in the waveform, that is, only addition is required. Therefore, the model can more effectively learn the data mapping patterns in the clipping restoration task. For this reason, the present disclosure considers performing clipping restoration in the time domain.

Based on the above considerations, the present disclosure proposes a universal audio clipping restoration method, which is applicable to practical video production scenarios. The method includes: a low-complexity clipping detection model configured to perform clipping detection in the frequency domain, and a robust universal clipping restoration model configured to perform clipping restoration in the time domain.

Correspondingly, the specific steps may include: first, acquiring audio data of a video file, converting each frame data in the audio data into frequency-domain data through a clipping detection model, and detecting whether clipping data exists in each frame data based on the frequency-domain data; then, performing, if it is detected that clipping data exists in the frame data, clipping restoration processing on the frame data through a clipping restoration model to obtain restored frame data, the clipping restoration model being configured to filter out clipping data and spectral mirroring from the frame data; and finally, performing normalization processing on audio loudness of the restored frame data based on a maximum amplitude of the restored frame data in a time domain, to obtain restored audio data of the video file.

In this technical solution, since clipping detection is performed in the frequency domain where distinct characteristics of clipping can be observed, the accuracy of clipping detection can be improved. Meanwhile, clipping restoration is performed in the time domain where it is only necessary to compensate for the clipped components in the waveform. This allows restoration of any audio content and any sampling rate, and is applicable to audio clipping in scenarios such as variable sampling, and codec distortions, etc., so that the accuracy of audio restoration can be improved.

An application scenario of an embodiment of the present disclosure is explained below:

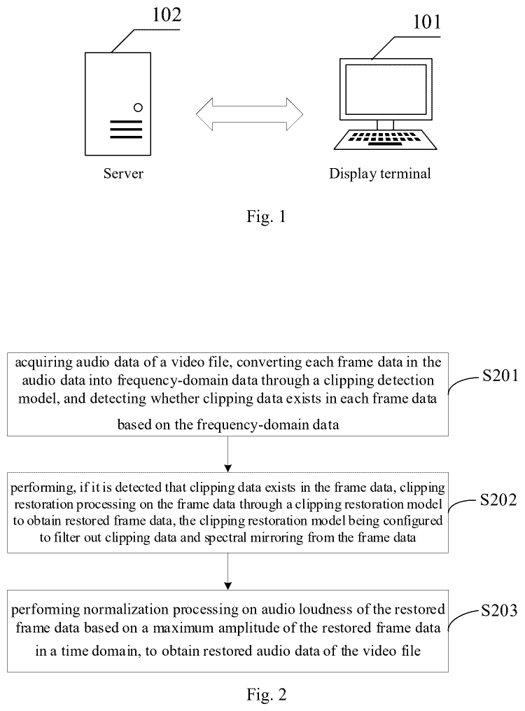

The audio processing method provided in the embodiment of the present disclosure can be applied to clipping restoration scenarios of various video files. FIG. 1 is a schematic diagram of an application scenario of an audio processing method provided by an embodiment of the present disclosure. As shown in FIG. 1, when a user sends a request for playing a video file to a server 102 through a terminal 101, the server 102 can perform clipping restoration on the video file using the audio processing method provided in the embodiment of the present disclosure. The server 102 returns the clipping-restored video file to the display terminal 101 for playback.

The following describes specific implementation processes of an audio processing method and device concerned in the embodiments of the present disclosure, and some examples are provided for illustration only and are not to be construed as limiting. The execution entity of the audio processing method concerned in the embodiments of the present disclosure is an electronic device, which may be a terminal, a server, or the like.

FIG. 2 is a first flowchart of an audio processing method provided in an embodiment of the present disclosure, and as shown in FIG. 2, the audio processing method may include:

S201, acquiring audio data of a video file, converting each frame data in the audio data into frequency-domain data through a clipping detection model, and detecting whether clipping data exists in each frame data based on the frequency-domain data.

In the embodiment of the present disclosure, the video file may be a video draft including audio data. Optionally, the video file is a video draft in video creative editing.

In order to better detect the existence of clipping while reducing the computational complexity as much as possible, the present disclosure proposes performing clipping detection in time-frequency domain and predicting whether clipping occurs by taking frame as a basic unit.

Optionally, the clipping detection model includes a feature extraction module and a clipping prediction module; correspondingly, detecting whether clipping data exists in each frame data based on the frequency-domain data includes: for each frame data, converting the frame data into frequency-domain data through Fourier transform; modeling local spectrum through the feature extraction module, and extracting a first frequency-domain feature configured to determine whether clipping occurs; performing compression processing on the first frequency-domain feature through the clipping prediction module to obtain a second frequency-domain feature of a preset dimension, and detecting whether clipping data exists in the frame data through the second frequency-domain feature.

Exemplarily, for each frame data, an input frame data time-domain waveform signal (i.e., frame data) can be transformed into frequency-domain data using a short-time Fourier transform with a frame length of 2048 and a frame shift of 512. The feature extraction module can model the transformed spectral data within the local spectrum using a hanning window as a window function, and extract the first frequency-domain feature configured to determine whether clipping occurs. The feature extraction module may include a plurality of two-dimensional convolutional modules.

Exemplarily, as shown in Table 1 below, the feature extraction module may include 5 two-dimensional convolution modules: two-dimensional convolution 1, two-dimensional convolution 2, two-dimensional convolution 3, two-dimensional convolution 4, and two-dimensional convolution 5.

TABLE 1
Clipping Detection Model

| | Network | Channel | Convolution | Step | | Input | Output |
|---|---|---|---|---|---|---|---|
| Layer id | layer | dimension | kernel | size | Padding | dimension | dimension |
| 1 | Two- | 3→8 | (8, 7) | (4, 1) | (2, 3) | [B, 3, 1024, T] | [B, 8, 256, T] |
| | dimensional | | | | | | |
| | convolution | | | | | | |
| | 1 | | | | | | |
| 2 | Two- | 8→16 | (8, 7) | (4, 1) | (2, 3) | [B, 8, 256, T] | [B, 16, 64, T] |
| | dimensional | | | | | | |
| | convolution | | | | | | |
| | 2 | | | | | | |
| 3 | Two- | 16→16 | (8, 7) | (4, 1) | (2, 3) | [B, 16, 64, T] | [B, 16, 16, T] |
| | dimensional | | | | | | |
| | convolution | | | | | | |
| | 3 | | | | | | |
| 4 | Two- | 16→32 | (8, 7) | (4, 1) | (2, 3) | [B, 16, 16, T] | [B, 32, 4, T] |
| | dimensional | | | | | | |
| | convolution | | | | | | |
| | 4 | | | | | | |
| 5 | Two- | 32→64 | (4, 7) | (2, 1) | (1, 3) | [B, 32, 4, T] | [B, 64, 2, T] |
| | dimensional | | | | | | |
| | convolution | | | | | | |
| | 5 | | | | | | |
| 6 | Clipping | — | — | — | — | [B, 64, 2, T] | [B, 64, T, 2] |
| | prediction | | | | | | |
| | module | | | | | | |
| 7 | Linear layer | 2→1 | — | — | — | [B, 64, T] | [B, 64, T] |
| 8 | One- | 64→1 | 3 | 1 | 1 | [B, 64, T] | [B, 1, T] |
| | dimensional | | | | | | |
| | convolution | | | | | | |
| | and Sigmoid | | | | | | |

B, T represent the batch size and the time frame, respectively.

Optionally, as shown in Table 1 above, the clipping prediction module includes a linear layer, a one-dimensional convolutional layer, and a Sigmoid nonlinear activation function. Correspondingly, compression processing is performed on the first frequency-domain feature through the clipping prediction module, to obtain a second frequency-domain feature of a preset dimension; detecting whether clipping data exists in the frame data through the second frequency-domain feature includes: performing compression processing on the first frequency-domain feature through the linear layer and the one-dimensional convolutional layer in the clipping prediction module, to obtain the second frequency-domain feature of the preset dimension; performing clipping detection on the frame data through the Sigmoid nonlinear activation function in the clipping prediction module and the second frequency-domain feature, and predicting a clipping probability corresponding to the frame data; if the clipping probability is greater than a preset probability, determining that clipping data exists in the frame data; if the clipping probability is not greater than the preset probability, determining that no clipping data exists in the frame data.

It should be noted that in the training stage, the present disclosure trains a detection model by adopting a regression task mode, and uses the root mean square error as the loss function. In the inference stage, given an input signal y(t)∈R^{1×S}, the specific steps of clipping detection are as follows:

Step 1: transforming y(t) into the frequency domain according to the short-time Fourier transform, obtaining the complex spectrum Y (f,t)∈C^{1024×T}.

Step 2: stacking the real and imaginary parts of the amplitude spectrum and complex spectrum, forming the input feature Feat∈R^{3×1024×T}.

Step 3: modeling local spectral features using the feature extraction module, and extracting a feature Feat_{local}∈R^{64×2×T}, which can be configured to determine whether clipping occurs.

Step 4: further detecting the clipping probability \hat{P}∈R^{1×T} of each frame using the clipping detection module.

Step 5: calculating a maximum windowed clipping ratio using a sliding window with the window length of N and the window shift of M, and returning.

S202, performing, if it is detected that clipping data exists in the frame data, clipping restoration processing on the frame data through a clipping restoration model to obtain restored frame data, the clipping restoration model being configured to filter out clipping data and spectral mirroring from the frame data.

Some existing audio generation models typically use a decoder to progressively generate target speech based on extracted audio representations. The decoder primarily consists of several upsampling layers. Due to the presence of the upsampling layers, such audio generation models are prone to spectral mirroring, and often need to rely on a reasonable discriminator for adversarial training, while the design of the discriminator affects the audio generation effect to a large extent. To achieve more robust clipping effect while simplifying the training process, the present disclosure proposes a time-domain clipping restoration model that can effectively avoids spectral mirroring.

Optionally, the restoration model includes an encoding module, a feature processing module, and an anti-mirroring decoding module; correspondingly, performing clipping restoration processing on the frame data through the clipping restoration model to obtain restored frame data includes: performing encoding processing on the frame data through the encoding module in the clipping restoration model, to obtain frame data of a preset feature dimension; extracting clipping-free target feature data from the frame data of the preset feature dimension through the feature processing module in the clipping restoration model; and performing decoding processing on the target feature data through the anti-mirroring decoding module in the clipping restoration model, and filtering out spectral mirroring from the target feature data, to obtain the restored frame data.

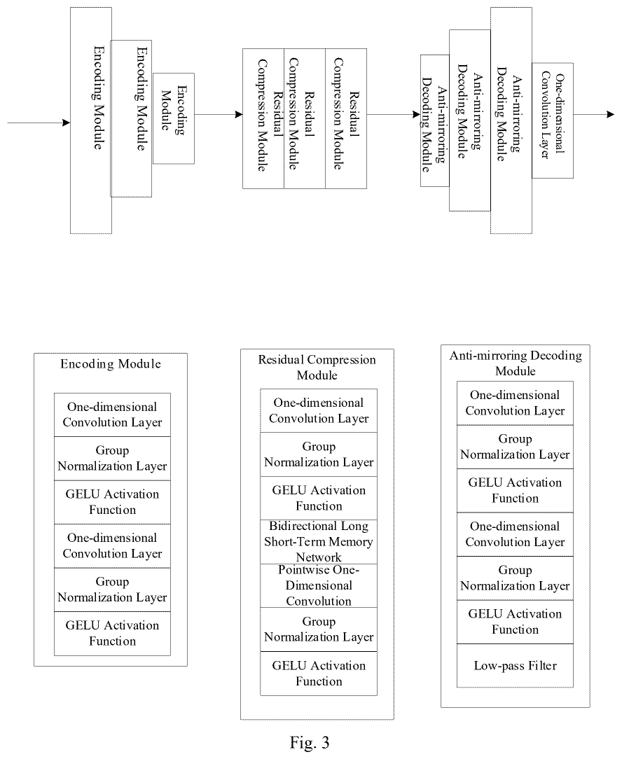

Exemplarily, the structure of the clipping restoration model is shown in FIG. 3. The clipping restoration model includes 3 modules: an encoding module, a feature processing module, and an anti-mirroring decoding module. The encoder firstly compresses an input time-domain signal in a time dimension, and expands the feature dimension, and it consists of a series of threshold one-dimensional convolution modules; the feature processing module extracts clipping related features based on the encoder output, and it consists of several layers of residual compression bidirectional long short-term memory network (BLSTM) modules; and finally, the anti-mirroring decoding module progressively upsamples the extracted features to recover clipping-free voice signals, while avoiding the generation of spectral mirroring, and it is symmetrical to the encoder, and consists of a series of anti-mirroring threshold one-dimensional deconvolution modules.

In some embodiments, performing encoding processing on the frame data through the encoding module in the clipping restoration model, to obtain frame data of a preset feature dimension includes: performing downsampling processing on the frame data through a first convolution layer in the encoding module of the clipping restoration model, to obtain frame data of a time dimension; and expanding the feature dimension of the frame data of the time dimension through a second convolution layer in the encoding module, to obtain the frame data of the preset feature dimension.

Exemplarily, as shown in FIG. 3, the encoding module consists of 7-layer one-dimensional threshold convolution modules, each one-dimensional threshold convolution module containing a one-dimensional convolution layer Conv1d, a group normalization layer GroupNorm, a GELU activation function layer, a one-dimensional convolution layer Conv1d, a group normalization layer GroupNorm, and a GLU non-linear activation function layer, where the first convolution layer is configured to perform downsampling, compress the time dimension and expand the feature dimension; the second convolution layer is configured to double the feature dimension for threshold control using GLU. The parameters of the encoding module are shown in Table 2 below.

TABLE 2
Parameters of the Encoding Module

| | Input | Output | Convolution | Step | |
|---|---|---|---|---|---|
| Layer id | channel | channel | kernel | size | GroupNorm |
| 1 | 1 | 32 | 8 | 1 | 1 |
| 2 | 32 | 64 | 8 | 4 | 1 |
| 3 | 64 | 128 | 8 | 4 | 1 |
| 4 | 128 | 256 | 8 | 4 | 2 |
| 5 | 256 | 512 | 4 | 2 | 2 |
| 6 | 512 | 1024 | 4 | 2 | 2 |
| 7 | 1024 | 1024 | 4 | 2 | 4 |

Optionally, extracting clipping-free target feature data from the frame data of the preset feature dimension through the feature processing module in the clipping restoration model includes: extracting the clipping-free target feature data from the frame data of the preset feature dimension through a bidirectional long short-term memory network BLSTM model in the feature processing module of the clipping restoration model.

Exemplarily, as shown in FIG. 3, the feature processing module consists of 3-layer residual compression DConv modules, each taking the form of residual connection and containing a one-dimensional convolution Conv1d, a group normalization GroupNorm, a GELU activation function, a bidirectional long short-term memory network BLSTM, a pointwise one-dimensional convolution Conv1d1×1, a group normalization layer GroupNorm, and a GLU nonlinear activation function. The first convolution is configured to compress the input feature dimension to reduce the complexity of subsequent BLSTM computations; the second convolution is configured to expand the feature dimension, filter out useful features using GLU, and restore the feature dimension. Each module has a consistent structure and a dimension compression factor of 4.

Optionally, the anti-mirroring decoding module includes a plurality of decoders and a filter; correspondingly, performing decoding processing on the target feature data through the anti-mirroring decoding module in the clipping restoration model, and filtering out spectral mirroring from the target feature data, to obtain the restored frame data includes: performing upsampling processing on the target feature data through the plurality of decoders in the clipping restoration model to obtain the restored initial frame data; and filtering out spectral mirroring from the initial frame data through the filter in the clipping restoration model to obtain the restored frame data.

Exemplarily, as shown in FIG. 3, the anti-mirroring decoding module consists of a 7-layer structure symmetrical to the encoding module, and the main difference is that the convolution of downsampling is transformed into a transposed convolution of upsampling. Furthermore, generating audio directly by upsampling is prone to generating spectral mirroring (due to random initialization of model parameters), and the mirroring depth depends on the multiple of upsampling. The greater the multiple, the deeper the mirroring depth, and the slower the model convergence. In order to avoid the problem, in the present disclosure, a low-pass filter is introduced in the last layer of each decoding module to explicitly filter out potential spectral mirroring, and meanwhile, in order to ensure that the finally obtained signals do not lose information, in the present disclosure, the output channel is kept consistent with the input in the last decoding module, and restoration signals without spectral mirroring are recovered by combining one-dimensional convolution after passing through the low-pass filter.

It should be noted that in the training stage, in order to get better listening quality while maintaining the consistency of time-domain waveforms, the present disclosure adopts multi-resolution STFTLoss and time-domain MAELoss to optimize the model. In addition, because the ratio of non-clipping segments in audio is often much smaller than that of clipping segments, the non-clipping segments have a small weight in calculating a loss function, and the model has a weak perception of the clipping restoration task, resulting in a limited restoration effect.

Thus, in the present disclosure, the loss function is calculated for the clipping segments and the non-clipping segments, respectively, and then a weighted summation is performed to obtain the final loss function, which is specifically defined as follows:

$${loss}_{wav} ( \hat{x} , x ) = MAE ( \hat{x} , x )$$

$${loss}_{specc}^{i} ( \hat{X} , X ) = \frac{{‖ ( \vert \hat{X} \vert - \vert X \vert ) ‖}_{F}}{{‖ \hat{X} ‖}_{F}} + MAE ( {log}_{10} \vert \hat{X} \vert , {log}_{10} \vert \hat{X} \vert )$$

$${loss}_{base} = {\sum }_{i = 1 , 2 , 3 , 4 , 5} {loss}_{specc}^{i} ( \hat{X} , X ) + α {loss}_{wav} ( \hat{x} , x )$$

$$loss = w * {loss}_{base}^{non - clipped} + ( 1 - w ) - {loss}_{base}^{clipped}$$

where x, \hat{x}, X, \hat{X} represent a target speech signal, a speech signal output by the model and their corresponding complex spectral features, respectively.

$${loss}_{spec}^{i} , i = 1 , 2 , 3 , 4 , 5$$

adopts short-time Fourier transform with a frame length of 640, 960, 1024, 1536 and 2048, respectively, a frame shift being ¼ of the frame length, the window function being a hanning window, α, w being weight control factors of loss function terms, where the values are 100 and 0.5 respectively.

It should be noted that, unlike a speech denoising task, the clipping restoration task is essentially a generative task, and it is difficult to achieve the expected effect by directly performing training with a mode of a regression task. Some existing methods often incorporate a generative adversarial network for training, employing the adversarial training between a discriminator and a generative model to achieve better effect. However, such methods involve a cumbersome training process, and their effect depends on the design of the discriminator. The present disclosure first conducts an in-depth analysis of the currently common time-domain model structure UNet, finding it easy to generate spectral mirroring and difficult to eliminate the mirroring by simply performing training with the mode of a regression task. However, after introducing a discriminator, the mirroring issue is gradually mitigated as the model training progresses. Based on the observation, the present disclosure considers how to overcome the generation of mirroring from the angle of the model structure, and the model training does not need to depend on the discriminator, thereby achieving a better restoration effect while simplifying the model training. Therefore, the present disclosure proposes an anti-mirroring time-domain network for the clipping restoration task, the proposed network model can effectively avoid the generation of spectral mirroring, and the robust clipping restoration effect can be obtained simply by using the training mode of a regression task.

When constructing training data, data augmentation is performed for secondary processing scenarios such as soft clipping, hard clipping, variable sampling, and codec distortions, and the sampling rate is randomly set, including random superposition of multiple sound sources such as music, human voice, and noise. The model takes time-domain waveforms as input and processes audio at different sample rates using the same operational mode. In the inference stage, given an input signal y(t)∈R^{1×S}, the specific steps of clipping restoration are as follows:

Step 1: compressing y(t)∈R^{1×S} in a time dimension using an encoder, and expanding a feature dimension, thus obtaining frame data F_{encoded}∈R^{C×S′} of a preset feature dimension.

Step 2: extracting a clipping-free audio feature F_{filtered}∈R^{C×S′} from F_{encoded} using a feature extraction module.

Step 3: recovering the clipping-restored signal \hat{x}∈R^{1×S} based on F_{filtered} through an anti-mirroring decoder.

S203, performing normalization processing on audio loudness of the restored frame data based on a maximum amplitude of the restored frame data in a time domain, to obtain restored audio data of the video file.

In an embodiment of the present disclosure, since an amplitude of the restored audio signal in the time-domain waveform is greater than that of the original signal, direct storage may result in re-clipping due to the limitation of the numerical range. Therefore, the present disclosure considers normalizing the loudness of the restored audio to −16 LUFS, and then normalizing the maximum amplitude using a limiter. It is worth mentioning that, unlike resulting in soft clipping due to excessive increase of the loudness and direct use of the limiter during video creation, the present disclosure first decreases the overall loudness, resulting in fewer sampling points wholly exceeding a threshold. As a result, the introduction of soft clipping after the limiter can be almost ignored.

Optionally, this step may include: determining the maximum amplitude of the restored frame data in a time domain; if the maximum amplitude is greater than a preset amplitude threshold, normalizing the audio loudness of the restored frame data to a preset audio loudness to obtain normalized frame data; reducing, through a limiter, an amplitude of the target frame data to the preset amplitude threshold, to obtain restored audio data of the video file, where the target frame data is the frame data in the normalized frame data with an amplitude greater than the preset amplitude threshold.

Exemplarily, given an audio signal y(t)∈R^{1×S}, here are the specific steps of a general method for clipping restoration:

Step 1: predicting the frame-level clipping ratio clipping_ratio through the clipping detection model.

Step 2: determining whether the frame-level clipping ratio clipping_ratio exceeds a certain threshold; if so, proceeding to the next step to perform clipping restoration; otherwise, ending and returning. The present disclosure uses a threshold of 0.5.

Step 3: directly inputting the time-domain signal into the clipping restoration model based on the anti-mirroring time-domain network, to obtain the restored audio \hat{x}(t).

Step 4: making statistics of the maximum amplitude Vmax of the restored audio in the time domain.

Step 5: if the maximum amplitude Vmax exceeds 1.0, limiting the audio loudness to −16LUFS, and limiting the maximum amplitude using the limiter; otherwise, returning the restored audio directly.

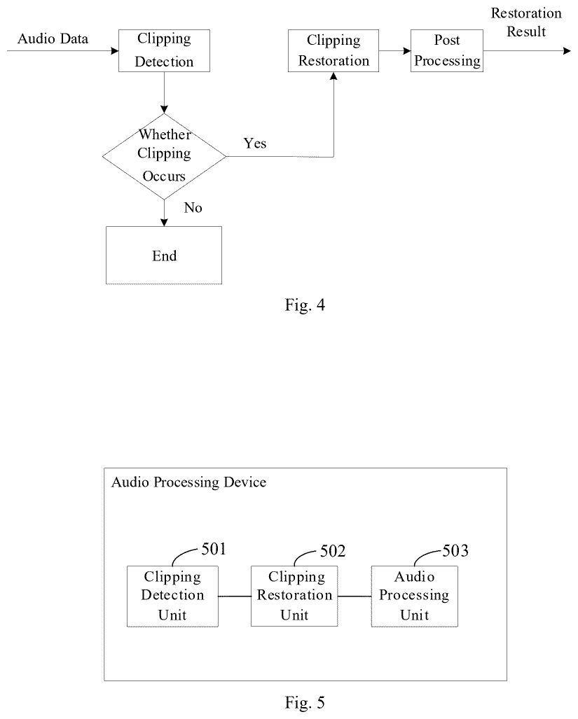

In view of the above, as shown in FIG. 4, the audio processing method in the present application includes three modules: a clipping detection module, a clipping restoration module, and a post-processing module. After an audio signal is given, first, it is determined whether the audio signal requires clipping restoration using the clipping detection model; for the signal that needs to be restored, the audio signal is restored using the clipping restoration model, and then the loudness is normalized using the post-processing module, thus avoiding re-clipping.

An embodiment of the present disclosure provides an audio processing method: first, acquiring audio data of a video file, converting each frame data in the audio data into frequency-domain data through a clipping detection model, and detecting whether clipping data exists in each frame data based on the frequency-domain data; then, performing, if it is detected that clipping data exists in the frame data, clipping restoration processing on the frame data through a clipping restoration model to obtain restored frame data, the clipping restoration model being configured to filter out clipping data and spectral mirroring from the frame data; finally, performing normalization processing on audio loudness of the restored frame data based on a maximum amplitude of the restored frame data in a time domain, to obtain restored audio data of the video file. In this technical solution, since clipping detection is performed in the frequency domain where distinct characteristics of clipping can be observed, the accuracy of clipping detection can be improved. Meanwhile, clipping restoration is performed in the time domain where it is only necessary to compensate for the clipped components in the waveform. This allows restoration of any audio content and any sampling rate, and is applicable to audio clipping in scenarios such as variable sampling, and codec distortions, etc., so that the accuracy of audio restoration can be improved.

FIG. 5 is a schematic structural diagram of an audio processing device provided in an embodiment of the present disclosure. As shown in FIG. 5, the audio processing device includes:
a clipping detection unit 501, configured to acquire audio data of a video file, convert each frame data in the audio data into frequency-domain data through a clipping detection model, and detect whether clipping data exists in each frame data based on the frequency-domain data;
a clipping restoration unit 502, configured to perform, if it is detected that clipping data exists in the frame data, clipping restoration processing on the frame data through a clipping restoration model to obtain restored frame data, the clipping restoration model being configured to filter out clipping data from the frame data;
an audio processing unit 503, configured to perform normalization processing on audio loudness of the restored frame data based on a maximum amplitude of the restored frame data in a time domain, to obtain restored audio data of the video file.

In accordance with one or more embodiments of the present disclosure, the clipping detection model includes a feature extraction module and a clipping prediction module; correspondingly, the detecting whether clipping data exists in each frame data based on the frequency-domain data includes: for each frame data of the audio data, converting a time-domain waveform signal corresponding to the frame data into frequency-domain data through Fourier transform; modeling local spectrum of the frequency-domain data through the feature extraction module, and extracting a first frequency-domain feature configured to determine whether clipping occurs; performing compression processing on the first frequency-domain feature through the clipping prediction module to obtain a second frequency-domain feature of a preset dimension, and detecting whether clipping data exists in the frame data through the second frequency-domain feature.

In accordance with one or more embodiments of the present disclosure, the clipping prediction module includes a linear layer, a one-dimensional convolution layer, and a Sigmoid nonlinear activation function; correspondingly, the performing compression processing on the first frequency-domain feature through the clipping prediction module to obtain a second frequency-domain feature of a preset dimension, and detecting whether clipping data exists in the frame data through the second frequency-domain feature includes: performing compression processing on the first frequency-domain feature through the linear layer and the one-dimensional convolution layer in the clipping prediction module to obtain the second frequency-domain feature of a preset dimension; performing clipping detection on the frame data through the Sigmoid nonlinear activation function in the clipping prediction module and the second frequency-domain feature, and predicting a clipping probability corresponding to the frame data; if the clipping probability is greater than a preset probability, determining that clipping data exists in the frame data, and if the clipping probability is not greater than the preset probability, determining that clipping data does not exist in the frame data.

In accordance with one or more embodiments of the present disclosure, the clipping restoration model includes an encoding module, a feature processing module, and an anti-mirroring decoding module; correspondingly, the performing clipping restoration processing on the frame data through a clipping restoration model to obtain restored frame data includes: performing encoding processing on the frame data through the encoding module in the clipping restoration model to obtain frame data of a preset feature dimension; extracting clipping-free target feature data from the frame data of the preset feature dimension through the feature processing module in the clipping restoration model; and performing decoding processing on the target feature data through the anti-mirroring decoding module in the clipping restoration model, and filtering out spectral mirroring from the target feature data to obtain restored frame data.

In accordance with one or more embodiments of the present disclosure, the performing encoding processing on the frame data through the encoding module in the clipping restoration model to obtain frame data of a preset feature dimension includes: performing downsampling processing on the frame data through a first convolution layer in the encoding module of the clipping restoration model to obtain frame data of a time dimension; and expanding a feature dimension of the frame data of the time dimension through a second convolution layer in the encoding module to obtain the frame data of the preset feature dimension.

In accordance with one or more embodiments of the present disclosure, the extracting clipping-free target feature data from the frame data of the preset feature dimension through the feature processing module in the clipping restoration model includes: extracting clipping-free target feature data from the frame data of the preset feature dimension through a bidirectional long-short-term memory network BLSTM model in the feature processing module of the clipping restoration model.

In accordance with one or more embodiments of the present disclosure, the anti-mirroring decoding module includes a plurality of decoders and a filter; correspondingly, the performing decoding processing on the target feature data through the anti-mirroring decoding module in the clipping restoration model, and filtering out spectral mirroring from the target feature data to obtain restored frame data includes: performing upsampling processing on the target feature data through the plurality of decoders in the clipping restoration model to obtain restored initial frame data; and filtering out spectral mirroring from the initial frame data through the filter in the clipping restoration model to obtain restored frame data.

In accordance with one or more embodiments of the present disclosure, the performing normalization processing on audio loudness of the restored frame data based on a maximum amplitude of the restored frame data in a time domain, to obtain restored audio data of the video file includes: determining the maximum amplitude of the restored frame data in a time domain; if the maximum amplitude is greater than a preset amplitude threshold, normalizing the audio loudness of the restored frame data to a preset audio loudness to obtain normalized frame data; and reducing, through a limiter, an amplitude of the target frame data to the preset amplitude threshold to obtain restored audio data of the video file, where the target frame data is the frame data in the normalized frame data with an amplitude greater than the preset amplitude threshold.

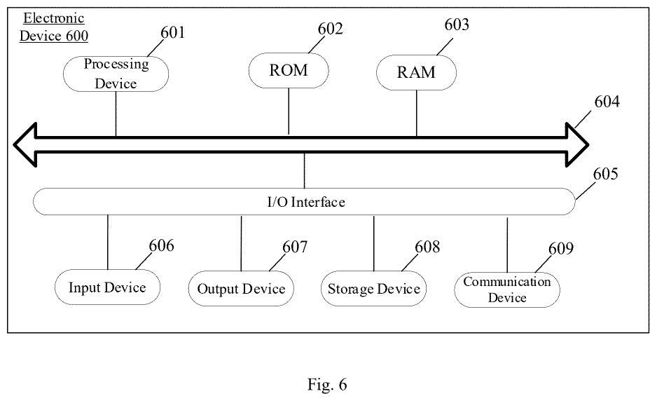

Referring to FIG. 6, which shows a schematic structural diagram of an electronic device 600 suitable for implementing an embodiment of the present disclosure. The electronic device 600 may be a terminal device or a server. The terminal device may include, but is not limited to, a mobile terminal such as a mobile phone, a notebook computer, a digital broadcast receiver, a personal digital assistant (PDA), a tablet computer, a portable multimedia player (PMP), an in-vehicle terminal (e.g., in-vehicle navigation terminal), and the like, and a fixed terminal such as a digital TV, a desktop computer, and the like. The electronic device shown in FIG. 6 is only an example, and should not bring any limitation to the functions and the scope of use of the embodiment of the present disclosure.

As shown in FIG. 6, the electronic device 600 may include a processing device (e.g., a central processing unit, a graphics processor, etc.) 601, which may perform various suitable actions and processes according to a program stored in a Read Only Memory (ROM) 602 or a program loaded from a storage device 608 into a Random Access Memory (RAM) 603. In the RAM 603, various programs and data necessary for the operation of the electronic device 600 are also stored.

The processing device 601, the ROM 602, and the RAM 603 are connected to each other via a bus 604. An input/output (I/O) interface 605 is also connected to the bus 604.

Generally, the following devices may be connected to the I/O interface 605: an input device 606 including, for example, a touch screen, a touch pad, a keyboard, a mouse, a camera, a microphone, an accelerometer, a gyroscope, etc.; an output device 607 including, for example, a liquid crystal display (LCD), a speaker, a vibrator, etc.; a storage device 608 including, for example, a magnetic tape, a hard disk, etc.; and a communication device 609. The communication means 609 may allow the electronic device 600 to communicate with other devices wirelessly or by wire to exchange data. While FIG. 6 illustrates the electronic device 600 having various devices, it is to be understood that not all illustrated devices are required to be implemented or provided. More or fewer devices may be alternatively implemented or provided.

In particular, the process described above with reference to the flow chart may be implemented as a computer software program, according to an embodiment of the present disclosure. For example, an embodiment of the present disclosure includes a computer program product including a computer program carried on a computer-readable medium, the computer program including program code for performing the method illustrated by the flow chart. In such an embodiment, the computer program may be downloaded and installed from a network via the communication device 609, or installed from the storage device 608, or installed from the ROM 602. The computer program, when executed by the processing device 601, performs the above-described functions defined in the method of the embodiment of the present disclosure.

It should be noted that the computer readable medium of the present disclosure may be a computer readable signal medium or a computer readable storage medium or any combination of the two. A computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store a program for use by or in connection with an instruction execution system, apparatus, or device. In contrast, in the present disclosure, a computer readable signal medium may include a propagated data signal with computer readable program code embodied therein, for example, in baseband or as part of a carrier wave. Such a propagated data signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to: electrical wires, optical cables, radio frequency (RF), etc., or any suitable combination of the foregoing.

The computer readable medium may be embodied in the electronic device; or may be separate and not incorporated into the electronic device.

The computer readable medium carries one or more programs which, when executed by the electronic device, cause the electronic device to perform the method shown in the above embodiment.

Computer program code for carrying out operations for aspects of the present disclosure may be written in any combination of one or more programming languages, including an object oriented programming language such as Java, Smalltalk, C++, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a Local Area Network (LAN) or a Wide Area Network (WAN), or the connection may be made to an external computer (for example, through the Internet using an Internet service provider).

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or operations, or combinations of special purpose hardware and computer instructions.

The units described in the embodiments of the present disclosure may be implemented by software or hardware. The name of a unit does not in some cases constitute a limitation of the unit itself, for example, the first obtaining unit may also be described as a “unit obtaining at least two internet protocol addresses”.

The functions described herein above may be performed, at least in part, by one or more hardware logic components. For example, without limitation, exemplary types of hardware logic components that may be used include: field Programmable Gate Arrays (FPGAs), Application Specific Integrated Circuits (ASICs), Application Specific Standard Products (ASSPs), system on a chip (SOCs), Complex Programmable Logic Devices (CPLDs), and the like.

In a first aspect, in accordance with one or more embodiments of the present disclosure, is provided an audio processing method, including:
acquiring audio data of a video file, converting each frame data in the audio data into frequency-domain data through a clipping detection model, and detecting whether clipping data exists in each frame data based on the frequency-domain data;
performing, if it is detected that clipping data exists in the frame data, clipping restoration processing on the frame data through a clipping restoration model to obtain restored frame data, the clipping restoration model being configured to filter out clipping data and spectral mirroring from the frame data; and
performing normalization processing on audio loudness of the restored frame data based on a maximum amplitude of the restored frame data in a time domain, to obtain restored audio data of the video file.

In accordance with one or more embodiments of the present disclosure, the clipping detection model includes a feature extraction module and a clipping prediction module; correspondingly, the detecting whether clipping data exists in each frame data based on the frequency-domain data includes: for each frame data of the audio data, converting a time-domain waveform signal corresponding to the frame data into frequency-domain data through Fourier transform; modeling local spectrum of the frequency-domain data through the feature extraction module, and extracting a first frequency-domain feature configured to determine whether clipping occurs; performing compression processing on the first frequency-domain feature through the clipping prediction module to obtain a second frequency-domain feature of a preset dimension, and detecting whether clipping data exists in the frame data through the second frequency-domain feature.

In accordance with one or more embodiments of the present disclosure, the clipping prediction module includes a linear layer, a one-dimensional convolution layer, and a Sigmoid nonlinear activation function; correspondingly, the performing compression processing on the first frequency-domain feature through the clipping prediction module to obtain a second frequency-domain feature of a preset dimension, and detecting whether clipping data exists in the frame data through the second frequency-domain feature includes: performing compression processing on the first frequency-domain feature through the linear layer and the one-dimensional convolution layer in the clipping prediction module to obtain the second frequency-domain feature of a preset dimension; performing clipping detection on the frame data through the Sigmoid nonlinear activation function in the clipping prediction module and the second frequency-domain feature, and predicting a clipping probability corresponding to the frame data; if the clipping probability is greater than a preset probability, determining that clipping data exists in the frame data, and if the clipping probability is not greater than the preset probability, determining that clipping data does not exist in the frame data.

In accordance with one or more embodiments of the present disclosure, the clipping restoration model includes an encoding module, a feature processing module, and an anti-mirroring decoding module; correspondingly, the performing clipping restoration processing on the frame data through a clipping restoration model to obtain restored frame data includes: performing encoding processing on the frame data through the encoding module in the clipping restoration model to obtain frame data of a preset feature dimension; extracting clipping-free target feature data from the frame data of the preset feature dimension through the feature processing module in the clipping restoration model; and performing decoding processing on the target feature data through the anti-mirroring decoding module in the clipping restoration model, and filtering out spectral mirroring from the target feature data to obtain restored frame data.

In accordance with one or more embodiments of the present disclosure, the performing encoding processing on the frame data through the encoding module in the clipping restoration model to obtain frame data of a preset feature dimension includes: performing downsampling processing on the frame data through a first convolution layer in the encoding module of the clipping restoration model to obtain frame data of a time dimension; and expanding a feature dimension of the frame data of the time dimension through a second convolution layer in the encoding module to obtain the frame data of the preset feature dimension.

In accordance with one or more embodiments of the present disclosure, the extracting clipping-free target feature data from the frame data of the preset feature dimension through the feature processing module in the clipping restoration model includes: extracting clipping-free target feature data from the frame data of the preset feature dimension through a bidirectional long-short-term memory network BLSTM model in the feature processing module of the clipping restoration model.

In accordance with one or more embodiments of the present disclosure, the anti-mirroring decoding module includes a plurality of decoders and a filter; correspondingly, the performing decoding processing on the target feature data through the anti-mirroring decoding module in the clipping restoration model, and filtering out spectral mirroring from the target feature data to obtain restored frame data includes: performing upsampling processing on the target feature data through the plurality of decoders in the clipping restoration model to obtain restored initial frame data; and filtering out spectral mirroring from the initial frame data through the filter in the clipping restoration model to obtain restored frame data.

In accordance with one or more embodiments of the present disclosure, the performing normalization processing on audio loudness of the restored frame data based on a maximum amplitude of the restored frame data in a time domain, to obtain restored audio data of the video file includes: determining the maximum amplitude of the restored frame data in a time domain; if the maximum amplitude is greater than a preset amplitude threshold, normalizing the audio loudness of the restored frame data to a preset audio loudness to obtain normalized frame data; and reducing, through a limiter, an amplitude of the target frame data to the preset amplitude threshold to obtain restored audio data of the video file, where the target frame data is the frame data in the normalized frame data with an amplitude greater than the preset amplitude threshold.

In a second aspect, in accordance with one or more embodiments of the present disclosure, is provided an audio processing device, including:
a clipping detection unit, configured to acquire audio data of a video file, convert each frame data in the audio data into frequency-domain data through a clipping detection model, and detect whether clipping data exists in each frame data based on the frequency-domain data;
a clipping restoration unit, configured to perform, if it is detected that clipping data exists in the frame data, clipping restoration processing on the frame data through a clipping restoration model to obtain restored frame data, the clipping restoration model being configured to filter out clipping data from the frame data;
an audio processing unit, configured to perform normalization processing on audio loudness of the restored frame data based on a maximum amplitude of the restored frame data in a time domain, to obtain restored audio data of the video file.

In accordance with one or more embodiments of the present disclosure, the clipping detection model includes a feature extraction module and a clipping prediction module; correspondingly, the detecting whether clipping data exists in each frame data based on the frequency-domain data includes: for each frame data of the audio data, converting a time-domain waveform signal corresponding to the frame data into frequency-domain data through Fourier transform; modeling local spectrum of the frequency-domain data through the feature extraction module, and extracting a first frequency-domain feature configured to determine whether clipping occurs; performing compression processing on the first frequency-domain feature through the clipping prediction module to obtain a second frequency-domain feature of a preset dimension, and detecting whether clipping data exists in the frame data through the second frequency-domain feature.

In accordance with one or more embodiments of the present disclosure, the clipping prediction module includes a linear layer, a one-dimensional convolution layer, and a Sigmoid nonlinear activation function; correspondingly, the performing compression processing on the first frequency-domain feature through the clipping prediction module to obtain a second frequency-domain feature of a preset dimension, and detecting whether clipping data exists in the frame data through the second frequency-domain feature includes: performing compression processing on the first frequency-domain feature through the linear layer and the one-dimensional convolution layer in the clipping prediction module to obtain the second frequency-domain feature of a preset dimension; performing clipping detection on the frame data through the Sigmoid nonlinear activation function in the clipping prediction module and the second frequency-domain feature, and predicting a clipping probability corresponding to the frame data; if the clipping probability is greater than a preset probability, determining that clipping data exists in the frame data, and if the clipping probability is not greater than the preset probability, determining that clipping data does not exist in the frame data.

In accordance with one or more embodiments of the present disclosure, the clipping restoration model includes an encoding module, a feature processing module, and an anti-mirroring decoding module; correspondingly, the performing clipping restoration processing on the frame data through a clipping restoration model to obtain restored frame data includes: performing encoding processing on the frame data through the encoding module in the clipping restoration model to obtain frame data of a preset feature dimension; extracting clipping-free target feature data from the frame data of the preset feature dimension through the feature processing module in the clipping restoration model; and performing decoding processing on the target feature data through the anti-mirroring decoding module in the clipping restoration model, and filtering out spectral mirroring from the target feature data to obtain restored frame data.

In accordance with one or more embodiments of the present disclosure, the performing encoding processing on the frame data through the encoding module in the clipping restoration model to obtain frame data of a preset feature dimension includes: performing downsampling processing on the frame data through a first convolution layer in the encoding module of the clipping restoration model to obtain frame data of a time dimension; and expanding a feature dimension of the frame data of the time dimension through a second convolution layer in the encoding module to obtain the frame data of the preset feature dimension.

In accordance with one or more embodiments of the present disclosure, the extracting clipping-free target feature data from the frame data of the preset feature dimension through the feature processing module in the clipping restoration model includes: extracting clipping-free target feature data from the frame data of the preset feature dimension through a bidirectional long-short-term memory network BLSTM model in the feature processing module of the clipping restoration model.

In accordance with one or more embodiments of the present disclosure, the anti-mirroring decoding module includes a plurality of decoders and a filter; correspondingly, the performing decoding processing on the target feature data through the anti-mirroring decoding module in the clipping restoration model, and filtering out spectral mirroring from the target feature data to obtain restored frame data includes: performing upsampling processing on the target feature data through the plurality of decoders in the clipping restoration model to obtain restored initial frame data; and filtering out spectral mirroring from the initial frame data through the filter in the clipping restoration model to obtain restored frame data.

In accordance with one or more embodiments of the present disclosure, the performing normalization processing on audio loudness of the restored frame data based on a maximum amplitude of the restored frame data in a time domain, to obtain restored audio data of the video file includes: determining the maximum amplitude of the restored frame data in a time domain; if the maximum amplitude is greater than a preset amplitude threshold, normalizing the audio loudness of the restored frame data to a preset audio loudness to obtain normalized frame data; and reducing, through a limiter, an amplitude of the target frame data to the preset amplitude threshold to obtain restored audio data of the video file, where the target frame data is the frame data in the normalized frame data with an amplitude greater than the preset amplitude threshold.

In a third aspect, in accordance with one or more embodiments of the present disclosure, is provided an electronic device, including: at least one processor and a memory;
where the memory stores computer-executable instructions; and
where the at least one processor executes the computer-executable instructions stored in the memory, causing the at least one processor to perform the audio processing method according to the first aspect and various possible designs of the first aspect as described above.

In a fourth aspect, in accordance with one or more embodiments of the present disclosure, is provided a computer-readable storage medium having computer-executable instructions stored thereon, where the computer-executable instructions, when executed by a processor, implement the audio processing method according to the first aspect and various possible designs of the first aspect as described above.

In a fifth aspect, in accordance with one or more embodiments of the present disclosure, is provided a computer program product including a computer program which, when executed by a processor, implements the audio processing method according to the first aspect and various possible designs of the first aspect as described above.

The foregoing description is only exemplary of the preferred embodiments of the present disclosure and is illustrative of the principles of the technology employed. It will be appreciated by those skilled in the art that the scope of the disclosure herein is not limited to the particular combination of features described above, but also encompasses other combinations of features described above or equivalents thereof without departing from the spirit of the disclosure. For example, the above features and the technical features disclosed in the present disclosure (but not limited to) having similar functions are replaced with each other to form the technical solution.

Further, while operations are depicted in a particular order, this should not be understood as requiring that such operations be performed in the particular order shown or in sequential order. Under certain circumstances, multitasking and parallel processing may be advantageous. Likewise, while several specific implementation details are included in the above discussion, these should not be construed as limitations on the scope of the disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An audio processing method, comprising:
acquiring audio data of a video file, converting each frame data in the audio data into frequency-domain data through a clipping detection model, and detecting whether clipping data exists in each frame data based on the frequency-domain data;
performing, if it is detected that clipping data exists in the frame data, clipping restoration processing on the frame data through a clipping restoration model to obtain restored frame data, wherein the clipping restoration model is configured to filter out the clipping data and spectral mirroring from the frame data;
performing normalization processing on audio loudness of the restored frame data based on a maximum amplitude of the restored frame data in a time domain, to obtain restored audio data of the video file.

2. The audio processing method according to claim 1, wherein the clipping detection model comprises a feature extraction module and a clipping prediction module; correspondingly, the detecting whether clipping data exists in each frame data based on the frequency-domain data comprises:
for each frame data of the audio data, converting a time-domain waveform signal corresponding to the frame data into the frequency-domain data through Fourier transform;
modeling local spectrum of the frequency-domain data through the feature extraction module, and extracting a first frequency-domain feature configured to determine whether clipping occurs;
performing compression processing on the first frequency-domain feature through the clipping prediction module to obtain a second frequency-domain feature of a preset dimension, and detecting whether clipping data exists in the frame data through the second frequency-domain feature.

3. The audio processing method according to claim 2, wherein the clipping prediction module comprises a linear layer, a one-dimensional convolution layer, and a Sigmoid nonlinear activation function; correspondingly, the performing compression processing on the first frequency-domain feature through the clipping prediction module to obtain a second frequency-domain feature of a preset dimension, and detecting whether clipping data exists in the frame data through the second frequency-domain feature comprises:
performing compression processing on the first frequency-domain feature through the linear layer and the one-dimensional convolution layer in the clipping prediction module to obtain the second frequency-domain feature of the preset dimension;
performing clipping detection on the frame data through the Sigmoid nonlinear activation function in the clipping prediction module and the second frequency-domain feature, and predicting a clipping probability corresponding to the frame data;
if the clipping probability is greater than a preset probability, determining that clipping data exists in the frame data, and if the clipping probability is not greater than the preset probability, determining that clipping data does not exist in the frame data.

4. The audio processing method according to claim 1, wherein the clipping restoration model comprises an encoding module, a feature processing module, and an anti-mirroring decoding module; correspondingly, the performing clipping restoration processing on the frame data through a clipping restoration model to obtain restored frame data comprises:
performing encoding processing on the frame data through the encoding module in the clipping restoration model to obtain the frame data of a preset feature dimension;
extracting clipping-free target feature data from the frame data of the preset feature dimension through the feature processing module in the clipping restoration model;
performing decoding processing on the target feature data through the anti-mirroring decoding module in the clipping restoration model, and filtering out the spectral mirroring from the target feature data to obtain the restored frame data.

5. The audio processing method according to claim 4, wherein the performing encoding processing on the frame data through the encoding module in the clipping restoration model to obtain the frame data of the preset feature dimension comprises:
performing downsampling processing on the frame data through a first convolution layer in the encoding module of the clipping restoration model to obtain the frame data of a time dimension;
expanding a feature dimension of the frame data of the time dimension through a second convolution layer in the encoding module to obtain the frame data of the preset feature dimension.

6. The audio processing method according to claim 4, wherein the extracting clipping-free target feature data from the frame data of the preset feature dimension through the feature processing module in the clipping restoration model comprises:
extracting clipping-free target feature data from the frame data of the preset feature dimension through a bidirectional long-short-term memory network BLSTM model in the feature processing module of the clipping restoration model.

7. The audio processing method according to claim 4, wherein the anti-mirroring decoding module comprises a plurality of decoders and a filter;
correspondingly, the performing decoding processing on the target feature data through the anti-mirroring decoding module in the clipping restoration model, and filtering out the spectral mirroring from the target feature data to obtain the restored frame data comprises:
performing upsampling processing on the target feature data through the plurality of decoders in the clipping restoration model to obtain restored initial frame data;
filtering out spectral mirroring from the initial frame data through the filter in the clipping restoration model to obtain the restored frame data.

8. The audio processing method according to claim 1, wherein the performing normalization processing on audio loudness of the restored frame data based on the maximum amplitude of the restored frame data in the time domain, to obtain restored audio data of the video file comprises:
determining the maximum amplitude of the restored frame data in the time domain;
if the maximum amplitude is greater than a preset amplitude threshold, normalizing the audio loudness of the restored frame data to a preset audio loudness to obtain normalized frame data;
reducing, through a limiter, an amplitude of the target frame data to the preset amplitude threshold to obtain restored audio data of the video file, wherein the target frame data is the frame data in the normalized frame data with an amplitude greater than the preset amplitude threshold.

9. An electronic device, comprising: a processor and a memory;
wherein the memory stores computer-executable instructions; and
wherein the processor executes the computer-executable instructions stored in the memory, causing the processor to perform an audio processing method, comprising:
acquiring audio data of a video file, converting each frame data in the audio data into frequency-domain data through a clipping detection model, and detecting whether clipping data exists in each frame data based on the frequency-domain data;
performing, if it is detected that clipping data exists in the frame data, clipping restoration processing on the frame data through a clipping restoration model to obtain restored frame data, wherein the clipping restoration model is configured to filter out the clipping data and spectral mirroring from the frame data;
performing normalization processing on audio loudness of the restored frame data based on a maximum amplitude of the restored frame data in a time domain, to obtain restored audio data of the video file.

10. The electronic device according to claim 9, wherein the clipping detection model comprises a feature extraction module and a clipping prediction module; correspondingly, the detecting whether clipping data exists in each frame data based on the frequency-domain data comprises:
for each frame data of the audio data, converting a time-domain waveform signal corresponding to the frame data into the frequency-domain data through Fourier transform;
modeling local spectrum of the frequency-domain data through the feature extraction module, and extracting a first frequency-domain feature configured to determine whether clipping occurs;
performing compression processing on the first frequency-domain feature through the clipping prediction module to obtain a second frequency-domain feature of a preset dimension, and detecting whether clipping data exists in the frame data through the second frequency-domain feature.

11. The electronic device according to claim 10, wherein the clipping prediction module comprises a linear layer, a one-dimensional convolution layer, and a Sigmoid nonlinear activation function; correspondingly, the performing compression processing on the first frequency-domain feature through the clipping prediction module to obtain a second frequency-domain feature of a preset dimension, and detecting whether clipping data exists in the frame data through the second frequency-domain feature comprises:
performing compression processing on the first frequency-domain feature through the linear layer and the one-dimensional convolution layer in the clipping prediction module to obtain the second frequency-domain feature of the preset dimension;
performing clipping detection on the frame data through the Sigmoid nonlinear activation function in the clipping prediction module and the second frequency-domain feature, and predicting a clipping probability corresponding to the frame data;
if the clipping probability is greater than a preset probability, determining that clipping data exists in the frame data, and if the clipping probability is not greater than the preset probability, determining that clipping data does not exist in the frame data.

12. The electronic device according to claim 9, wherein the clipping restoration model comprises an encoding module, a feature processing module, and an anti-mirroring decoding module; correspondingly, the performing clipping restoration processing on the frame data through a clipping restoration model to obtain restored frame data comprises:
performing encoding processing on the frame data through the encoding module in the clipping restoration model to obtain the frame data of a preset feature dimension;
extracting clipping-free target feature data from the frame data of the preset feature dimension through the feature processing module in the clipping restoration model;
performing decoding processing on the target feature data through the anti-mirroring decoding module in the clipping restoration model, and filtering out the spectral mirroring from the target feature data to obtain the restored frame data.

13. The electronic device according to claim 12, wherein the performing encoding processing on the frame data through the encoding module in the clipping restoration model to obtain the frame data of the preset feature dimension comprises:
performing downsampling processing on the frame data through a first convolution layer in the encoding module of the clipping restoration model to obtain the frame data of a time dimension;
expanding a feature dimension of the frame data of the time dimension through a second convolution layer in the encoding module to obtain the frame data of the preset feature dimension.

14. The electronic device according to claim 12, wherein the extracting clipping-free target feature data from the frame data of the preset feature dimension through the feature processing module in the clipping restoration model comprises:
extracting clipping-free target feature data from the frame data of the preset feature dimension through a bidirectional long-short-term memory network BLSTM model in the feature processing module of the clipping restoration model.

15. A non-transitory computer-readable storage medium, having computer-executable instructions stored thereon, wherein the computer-executable instructions, when executed by a processor, implement an audio processing method, comprising:
acquiring audio data of a video file, converting each frame data in the audio data into frequency-domain data through a clipping detection model, and detecting whether clipping data exists in each frame data based on the frequency-domain data;
performing, if it is detected that clipping data exists in the frame data, clipping restoration processing on the frame data through a clipping restoration model to obtain restored frame data, wherein the clipping restoration model is configured to filter out the clipping data and spectral mirroring from the frame data;
performing normalization processing on audio loudness of the restored frame data based on a maximum amplitude of the restored frame data in a time domain, to obtain restored audio data of the video file.

16. The non-transitory computer-readable storage medium according to claim 15, wherein the clipping detection model comprises a feature extraction module and a clipping prediction module;
correspondingly, the detecting whether clipping data exists in each frame data based on the frequency-domain data comprises:
for each frame data of the audio data, converting a time-domain waveform signal corresponding to the frame data into the frequency-domain data through Fourier transform;
modeling local spectrum of the frequency-domain data through the feature extraction module, and extracting a first frequency-domain feature configured to determine whether clipping occurs;
performing compression processing on the first frequency-domain feature through the clipping prediction module to obtain a second frequency-domain feature of a preset dimension, and detecting whether clipping data exists in the frame data through the second frequency-domain feature.

17. The non-transitory computer-readable storage medium according to claim 16, wherein the clipping prediction module comprises a linear layer, a one-dimensional convolution layer, and a Sigmoid nonlinear activation function; correspondingly, the performing compression processing on the first frequency-domain feature through the clipping prediction module to obtain a second frequency-domain feature of a preset dimension, and detecting whether clipping data exists in the frame data through the second frequency-domain feature comprises:
performing compression processing on the first frequency-domain feature through the linear layer and the one-dimensional convolution layer in the clipping prediction module to obtain the second frequency-domain feature of the preset dimension;
performing clipping detection on the frame data through the Sigmoid nonlinear activation function in the clipping prediction module and the second frequency-domain feature, and predicting a clipping probability corresponding to the frame data;
if the clipping probability is greater than a preset probability, determining that clipping data exists in the frame data, and if the clipping probability is not greater than the preset probability, determining that clipping data does not exist in the frame data.

18. The non-transitory computer-readable storage medium according to claim 15, wherein the clipping restoration model comprises an encoding module, a feature processing module, and an anti-mirroring decoding module; correspondingly, the performing clipping restoration processing on the frame data through a clipping restoration model to obtain restored frame data comprises:
performing encoding processing on the frame data through the encoding module in the clipping restoration model to obtain the frame data of a preset feature dimension;
extracting clipping-free target feature data from the frame data of the preset feature dimension through the feature processing module in the clipping restoration model;
performing decoding processing on the target feature data through the anti-mirroring decoding module in the clipping restoration model, and filtering out the spectral mirroring from the target feature data to obtain the restored frame data.

19. The non-transitory computer-readable storage medium according to claim 18, wherein the performing encoding processing on the frame data through the encoding module in the clipping restoration model to obtain the frame data of the preset feature dimension comprises:
performing downsampling processing on the frame data through a first convolution layer in the encoding module of the clipping restoration model to obtain the frame data of a time dimension;
expanding a feature dimension of the frame data of the time dimension through a second convolution layer in the encoding module to obtain the frame data of the preset feature dimension.

20. The non-transitory computer-readable storage medium according to claim 18, wherein the extracting clipping-free target feature data from the frame data of the preset feature dimension through the feature processing module in the clipping restoration model comprises:
extracting clipping-free target feature data from the frame data of the preset feature dimension through a bidirectional long-short-term memory network BLSTM model in the feature processing module of the clipping restoration model.
